(19) United States
(12) Patent Application Publication
(10) Pub. No.: US 2008/0141293 A1
(43) Pub. Date: Jun. 12, 2008

(54) CONVENIENT PARENTAL RESTRICTION CONTROL OF VIDEO OUTPUT

(75) Inventors: Robert Blanchard, Escondido, CA (US); Peter Shintani, San Diego, CA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignees: Sony Corporation, Tokyo (JP); Sony Electronics Inc., Park Ridge, NJ (US)

(21) Appl. No.: 11/608,755

(22) Filed: Dec. 8, 2006

(51) Int. Cl. H04N 7/16

(52) U.S. Cl. 725/28

(57) ABSTRACT

Apparatus and method for temporarily adjusting parental control restrictions without password entry or traversing configuration menus within a video device configured for displaying video or outputting a video stream to a display. Parental control can be implemented on television sets, fixed and removable video player devices, gaming consoles and personal computers. One implementation describes the use of a separate remote control device for adjusting parental control restrictions, such as automatically lifting the restrictions when the remote control is detected within a desired proximity of the video device. Alternatively, or additionally, the user can set a level of restriction using the remote control. One implementation describes an integrated bio-metric sensor device configured for identifying the individual as one for which the restrictions are to be adjusted. One implementation modifies the electronic program guide (EPG) in response to the presence of the supervisory party.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to video output devices, and more particularly to parental control restrictions on video systems.

2. Description of Related Art

A number of conventional television sets and other video devices and systems are configured to allow a responsible party to traverse a set of menus, enter a ‘secret’ password, and then manipulate the parental control restriction level for the device. Situations arise in which this form of parental control can become a time consuming bother.

Accordingly, a need exists for a system and method of quickly and temporarily changing parental restrictions without the need to enter passwords or traverse menu trees. These needs and others are met within the present invention, which overcomes the deficiencies of previously developed video output apparatus and methods.

### BRIEF SUMMARY OF THE INVENTION

An apparatus, system and/or method are described for controlling video output in response to parental control settings. According to the teachings herein, when a responsible party (e.g., parent or other supervisory individual, or individuals), is present near the video device (e.g., within the same room) the content restrictions are lifted or altered without the necessity of traversing a menuing system or entering a password. One aspect describes modification of the electronic program guide or channel guide in response to the acknowledged presence of the supervisory authority thus limiting the temptations of children. Implementations are described which utilize, separately or in various combination, remote control devices, bio-metric scans for identifying a supervisory person(s) or associated device.

As an aid to understanding the present invention, information follows about some of the terms utilized within the specification and claims, however, it is to be appreciated that these are provided for convenience and not as a substitute for other recitations within the specification and claims. These are listed in alphabetic order.

“Bio-metric sensor/identifier” refers to a mechanism for uniquely identifying the presence of a specific individual, or an individual from a collection of individuals for which at least one bio-metric identifier has been obtained and stored in a database or similar data repository by the apparatus or system taught herein. Typical bio-metric identifiers include fingerprints, thumbprints, vein pattern scans, iris patterns, and other mechanisms which are available or will become available. It will be appreciated that the terms “fingerprints” and “thumbprints” are functionally interchangeable, the difference of course being that the digit being ‘pressed’ into service differs. Typically a simple verification system is setup to check one particular finger against a print for that person within an associated data base.

“Electronic program guide (EPG)” as used herein refers to any channel map for broadcast, cable, satellite or other content. Typically, an EPG allows the user to check what is available for viewing across a number of channels, and/or sources. Some electronic program guides are configured to interact with the system for selecting content to watch and/or to record. Although the function may be called by a number of different terms, such as by different manufacturers, the term is used herein in the general sense of mapping, or otherwise indicating, content that is available for access.

“Parental control restriction” as used herein refers to the ability to restrict what media content (also referred to a media programming) is allowed to be output. Similar functionality may be known by a number of different terms, which need not be specific to ‘parent control’, without departing from its use herein. A rating is associated with the media programming or content, also called video source content, such as the G, PG, PG-13, R, and so forth found at a movie theatre, however, this rating can be divided into different categories such as violence, sexual content, language and so forth. The present system is configured for operation with any type of encoding of these ratings and any means of retrieving ratings and associating them with the source content. For example, although ratings are preferably received in combination with source content, they may be obtained over the same or different media than the content that is being obtained, such as received over the Internet. It will be appreciated that one of ordinary skill in the art will recognize mechanisms necessary for collecting ratings for any desired content. It should also be noted that the present teachings can be implemented for controlling a single type of rating, or multiple rating types, wherein the term “restriction” is thus not limited to the singular, nor does the use of the terms “restriction(s)” or “restrictions” connote the necessity of controlling multiple rating types.

“Parent”, “supervisory party”, “selected individual” are terms utilized with respect to setting the ‘parental’ control restrictions. The term “parent” is particularly well-suited for the parent-child content control situation, however, it will be appreciated that the present invention may be utilized in other situations. The term “supervisory party, person, or individual”, or similar language in either singular or plural tenses, addresses that the person, or persons, which is supervising content viewing may be other than the parent. The term “selected individual, person, or party” in the singular or plural form herein connotes that from the system perspective it does not matter how these parties gained their supervisory authority, only that they have been selected from the standpoint of the system (information entry context) to establish these settings. All of these terms are used in various contexts and are substantially interchangeable within the invention to refer to the same party or parties for any given application of the present teachings.

It should also be appreciated that the presence of the parent or supervisory individual can be determined actively or passively. By way of example, an active determination is one in which the supervisor must actively indicate their presence, such as registering a bio-metric identifier, while a passive identifier is one that can be registered without direct user interaction, such as a parent being detected as present based on detecting the presence of their key fob, or other electronic device which communicates with the system. It will be appreciated that active and passive detection in this context can overlap, as it will be noted that the user can choose to leave the key fob in another room. The presence of a parent or supervisory individual thus encompasses both the use of passive and active methods of presence determination.

“Temporary” is recited with regard to the change in parental control restrictions and is intended to mean that the new restriction level remains for some period of time. Examples of establishing this time period include: (1) for a given period of time (e.g., predetermined or established in response to conditions), (2) for as long as the individual is detected in the room, (3) for a period of X minutes after that individual leaves the room, (4) for the duration of the content being viewed, or (5) of limited duration as based on similar alternatives and combinations thereof.

“Video device” as used herein refers to an electronic device configured for displaying a video stream, or generating a video stream for connection to a video display. The term “video” is utilized herein in its larger context as including video images of any desired resolution (e.g., SD, HD, and the like) preferably accompanied by at least one audio channel. However, it should be appreciated that the present invention can be implemented, as desired, for performing parental control of strictly the video portion of the video content.

The invention is amenable to being embodied in a number of ways, including but not limited to the following descriptions.

One implementation of the invention can be generally described as a system or apparatus, comprising: (a) means for generating a video output from a video content source; (b) means for preventing the output of selected video content (i.e., for display on a screen) in response to detecting that its rating is incompatible with a parental control restriction setting; and (c) means for temporarily changing parental control restrictions in response to identifying the presence of at least one selected individual, or a device associated that at least one selected individual.

In one implementation, the means for temporarily changing parental control restrictions is configured for lifting content restrictions in response to identifying that at least one selected individual is proximal to the apparatus and can supervise viewing. The presence of the individual being determined in response to the detection of the individual(s) or a device associated with that selected individual(s). The means for changing the restrictions also allows the parent to view unrestricted content without having to first change the content restriction settings. Alternatively, the content restriction setting can be changed, such as in response to input from the one or more selected individual. In either case, the temporary changing of parental content restrictions is executed without requiring user entry of a password, or the traversal of one or more menus. In an alternate implementation, or mode, the restrictions are increased to a desired level (e.g., predetermined or in response to other conditions) when the supervisory party leaves the vicinity. In another implementation, or mode, the video output is deactivated (e.g., put into a stand-by mode, an off mode, a blanking mode, or less preferably by performing a content switch or selection) when the supervisory party leaves the vicinity. By way of example and not limitation, detection that the supervisor has left the vicinity can comprise determining that a wireless key device is out of range, or is otherwise beyond some established threshold for range and/or position.

The parental control restrictions as established within the video device preferably comprise a threshold for selecting content in at least one category for viewing, if the rating of the given content element in that category is within the parental control threshold setting then the given content element will be output for viewing. The restrictions can alternatively define the content that is to be restricted, instead of that which is to be allowed.

A means is provided in the system for identifying the presence of at least one selected individual. In one embodiment of the invention a mechanical or electrical key device is provided which is configured for communicating in response to being located proximal to the apparatus. The key device can be detected on the basis of adjacent proximity, such as being engaged with the apparatus (i.e., establishing electrical contact therewith), or kept within approximately two or three feet thereof (i.e., inductively coupled).

The key device can be implemented as a mechanical or electronic device that is held proximal to, or inserted within, either the video output device itself, or a remote control device used to control functionality of the output device.

A wireless communications protocol can be utilized with the key device wherein the system continually or periodically detects the relative location (e.g., proximal, in-range, out of range) of the key device. The wireless configuration can be implemented in a number of ways.

One implementation of the key device utilizes the electrical key device in combination with a wireless remote control configured for communicating with the video output device, thus extending the range of the key device to that of the remote control. In this way, the key device functionality is coupled to a conventional remote control used for controlling the operation of the video output device.

The key device functions are more preferably incorporated as part of a small separate remote control device which is configured for controlling parental control restrictions and not for controlling basic functions of the video device to which it is associated. Using a separate remote control device has the advantage that the user can keep this small remote device in their possession, or stored safely away, such that other parties (i.e., children) are unable to readily obtain the device for overriding the parental restrictions. This small remote could be in the form of a key fob device which is easily retained in a pocket or part of a key ring. In general terms a key fob is a medallion residing on, or associated with a key ring. The term is more recently used to refer to a small form factor electronic security, identification and/or data key device, which typically can or could be attached to a key ring.

In one implementation a separate remote control device incorporates a radio-frequency identification circuit for responding to challenges transmitted from the video apparatus. For example, the remote control can comprise a circuit which remains in a passive mode until receiving a periodic challenge signal from the apparatus. The power from the challenge can be used to drive a response from the remote, even for registering user interface states (i.e., button closures) which are communicated back to the apparatus. In this way the remote control device can be designed without the need of an internal power source. Alternatively, semi-passive or active remote controls can be implemented which utilize batteries, photocells, and/or the like to provide all of a portion of their operating power.

The means for detecting the presence of at least one selected individual, can alternatively, or additionally, be implemented through the use of a bio-metric sensor, such as a finger print sensing device. The bio-metric sensor can be incorporated within the video apparatus itself, or in the remote control for operating the video device, or in a separate remote control device. Regardless of which device it is incorporated, the sensor assures that the selected individual (e.g., parent(s) or supervisor(s)) is in the room when the video is being output. Bio-metric information is collected about the supervisory individuals which is stored in a database, or similar repository, for subsequent comparison against information retrieved from bio-metric scans.

It should be appreciated that a number of different apparatus can incorporate the restriction control apparatus and/or methods of the present invention, including the following and combinations thereof which are presented by way of example: analog TV sets, digital TV sets, set top boxes, video players, fixed media players, digital video recorders (DVRs), removable media players, digital video disc (DVD) players, personal computers, video gaming systems, and other electronic systems configured for displaying video (e.g., television) or generating a video output for being displayed on a video display device (e.g., video monitor). These apparatus can receive internal or external video content sources. Examples of internal content sources include fixed media storage, removable media storage, and the like. Examples of external content sources comprise content from any external sources, such as external devices and broadcast content forms delivered over radio frequency, Internet, cable, satellite, local network, and combinations thereof.

The video output apparatus can be implemented utilizing conventional electronic architectures, for example using a microprocessor or other circuit containing at least one computer processor and associated memory from which programming is executed for performing the functions of the video output device as well as processing the parental restrictions.

The present teachings also present a method of adjusting parental control of video output, comprising: (a) entering identifiers into a data store of a video device, for at least one individual or device associated with the individual, for which parental control restrictions are to be adjusted; (b) establishing a parental control restriction setting for controlling the ratings of content whose video is being output by a video device; (c) generating a video output from a video content source when the ratings of the video content source is compatible with the parental control restriction setting; and (d) temporarily changing parental control restrictions in response to detecting the presence of at least one supervisory individual, or the device associated with the at least one supervisory individual.

In one implementation, or mode, of this method the changing of parental control restrictions can be performed by (i) automatically defeating all the parental control restrictions in response to detecting the presence of at least one supervisory individual, or the device associated with the supervisory individual, or (ii) receiving a user input from one or more of the supervisory individuals, or the device associated with the at least one supervisory individual, and setting the parental control restriction(s) in response to this user input. Alternatively, input from the user (i.e., supervisory individual) can provide for establishing a change in the parental content restriction. The change in parental control restrictions according to the present teachings are configured for being maintained only for a limited duration (temporarily) after which the original parental content restrictions are reinstated.

The method can further comprise (i) automatically communicating with a remote control device that is brought into sufficiently close proximity; and (ii) temporarily changing parental control restrictions in response to verifying that information about the remote control, or the individual associated with the remote control, is found in the data store as associated with a supervisory individual for which parental control restrictions are to be adjusted.

The method can also include specific methods of detecting the presence of supervisory individuals, such as including: (i) receiving bio-metric information from a bio-metric sensor integrated on a remote control device which is proximal to the video device; (ii) the remote control configured for communicating bio-metric identification for a supervising individual utilizing the remote control; (iii) looking up the bio-metric information in the data store of the video device; and (iv) temporarily changing parental restrictions in response to finding a match between the bio-metric information and identifiers within the data store of supervisory individuals for which parental control restrictions are to be adjusted.

Described within the teachings of the present invention are a number of inventive aspects, including but not necessarily limited to the following.

An aspect of the invention is to provide for the rapid changing of parental restrictions on video content in response to the presence of a supervisory individual (e.g., parents).

Another aspect of the invention is to provide for temporary changes of content restrictions without the need of password entry or traversing menuing trees by supervisory individual(s) which are responsible for supervising content viewing at that location.

Another aspect of the invention is to provide for temporarily changing content restrictions to a predetermined setting in response to detecting whether at least one selected individual or supervising party is nearby.

Another aspect of the invention is to provide for deactivating the video output of the video device (e.g., stand-by mode, off mode, blanking, content source switching) in response to detecting that a supervising party is no longer nearby.

Another aspect of the invention is to provide a key (electronic or mechanical) which provides a token indicative of the presence of the selected supervisory party or parties.

Another aspect of the invention is to provide for adjustment of parental control settings in response to utilizing a separate remote control that remains in the possession of at least one supervisory individual.

Another aspect of the invention is to provide for the temporary adjustment of parental control settings in response to the receipt of bio-metric identifiers for a supervisory individual(s) detected nearby the video device or one or more remote controls associated with the supervisory individual(s).

Another aspect of the invention is incorporation of temporary content restriction adjustments within a wide range of video apparatus, such as television sets, video players, set top boxes, personal computers, game players and so forth.

A still further aspect of the invention is incorporation of a means for automatically changing the electronic program guide (EPG), or similar, in response to detecting the presence or absence of a supervisory individual, or a device associated with the supervisory individual.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of the convenient mode control apparatus in accordance to an embodiment of the present invention.

FIG. 2 is a flow diagram of the temporary parental restriction control method according to an embodiment of the present invention.

FIG. 3 is a flow diagram of the temporary parental restriction control method according to another embodiment of the present invention.

FIG. 4 is a flow diagram of automated modification of the electronic program guide (EPG) in response to supervisory authority.

### DETAILED DESCRIPTION OF THE INVENTION

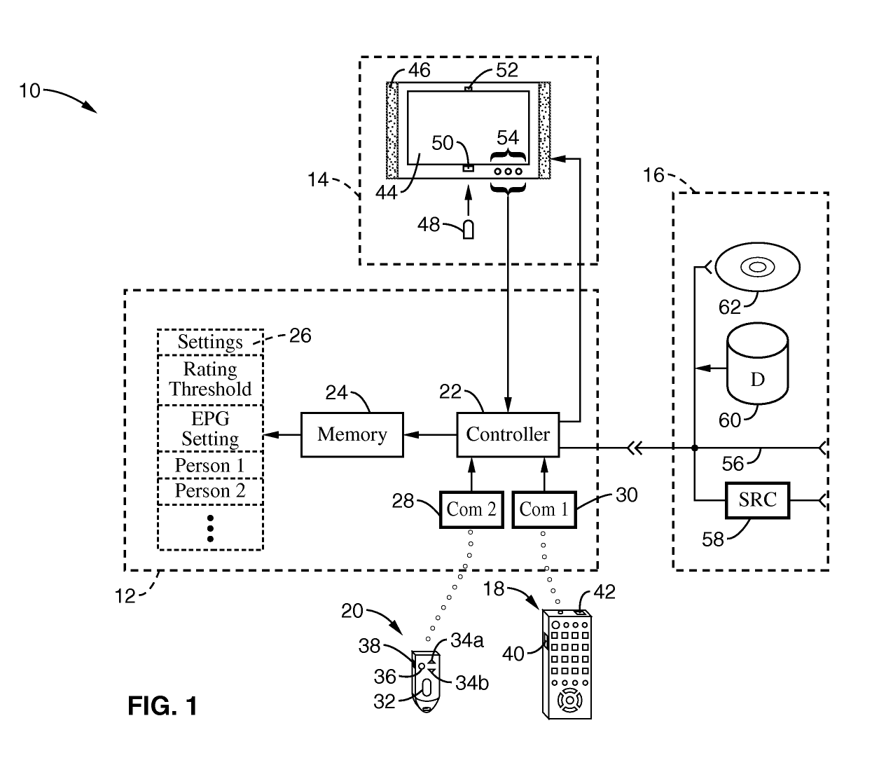

Referring more specifically to the drawings, for illustrative purposes the present invention is embodied in the apparatus generally shown in FIG. 1 through FIG. 4. It will be appreciated that the apparatus may vary as to configuration and as to details of the parts, and that the method may vary as to the specific steps and sequence, without departing from the basic concepts as disclosed herein.

FIG. 1 illustrates an example embodiment 10 of a convenient mode control apparatus. A control circuit 12 is shown for controlling video content output in response to parental control restriction settings, and for temporarily adjusting those restrictions. An output device 14 is shown for outputting video from control circuit 12. Additionally, a group of video content sources is shown in block 16 as representative of the types of content for which the parental control restrictions can apply.

A first remote control 18 is shown which is configured for controlling conventional operations of control circuit 12, and optionally output device 14 and/or source devices 16. Remote control 18 can be adapted according to the present invention for temporarily adjusting parental control restrictions. A second, separate, remote control 20 is shown which is configured for determining whether or not an individual, such as a parent, is supervising the content viewing.

Considering control circuit 12, it can be seen in the figure to contain a controller 22 coupled to a data repository, such as memory 24, which is configured for maintaining information 26 about the parental restriction controls and supervisory individuals or associated devices. By way of example and not limitation, information 26 is illustrated as settings, rating thresholds, electronic program guide (EPG) settings, and persons. The settings are received from the user, which can generally be equated as a supervisory party, or in response to characteristics of the specific system into which control circuit 12 is integrated. These settings can include durations or events to which the temporary adjustments to parent restrictions are to be enacted, as well as the conditions for which parental supervision, or temporary override, is to be disabled. These parameters can also establish if and how the electronic program guide is to be modified in response to the presence/absence of a supervisory party. It will be appreciated that the functioning of the system can be modified as desired by these settings. The rating threshold provides for the storage of at least an established restriction setting and a temporary restriction setting. Alternatively, or additionally, a number of threshold settings can be maintained, such as to allow for selection of different parental control restrictions under different situations. The information about persons preferably provides information on how the presence of these persons is to be identified, for example an ID for an associated device (e.g., remote control) or a bio-metric identifier.

Controller circuit 22 is shown configured for receiving video content from one or more content sources 16 and selectively outputting this content in response to the parental control restrictions to a video output device 14. Control inputs to controller circuit 22 are exemplified as two communication channels, com1 28 and com2 30, utilizing any desired wireless communication medium and protocol (e.g., radio-frequency, electric fields, inductive sense, optical, magnetic, audio and so forth). These communication ports are configured for receiving input from remote control devices, although control input can be alternatively, or additionally, received from a user interface, and/or directly from other devices or from a communication network such as over the Internet.

Controller circuit 22 incorporates one or more computational elements, such as microcontrollers, microprocessors, digital signal processors, or similar devices which can execute programming, such as for performing the methods taught herein. The operation of control circuit 22 is performed in response to stored data, such as in memory 24, which contains settings, rating thresholds, and information about the individuals to which changes in the content restrictions are to be accepted. It should also be appreciated that the programming for the methods taught herein can be provided in the form of instructions, media, downloads and so forth, which can be executed on video devices which have a capability for detecting the presence of a supervisory person, or which can be augmented with this capability.

The parental restriction control of the present invention can be integrated within any video apparatus supporting a video display or a video output for being displayed. Examples of these video apparatus include the following devices and combinations: analog TV sets, digital TV sets, set top boxes, video players, fixed media players, digital video recorders (DVRs), removable media players, digital video disc (DVD) players, personal computers, video gaming systems, and other electronic systems configured for displaying video (e.g., television) or generating a video output for being displayed on a video display device (e.g., video monitor).

These apparatus can receive content from internal or external video content sources and selectively direct video output when the content ratings are compatible with parental restriction settings. Examples of internal video content sources comprise fixed media video devices, removable media video devices, and gaming devices. Examples of external content sources comprise broadcast content forms such as radio frequency, Internet, cable, satellite, local network, and combinations thereof. The content sources within group 16 can comprise any of the following: a content input 56 (e.g., IP connection, USB, and so forth), a converted content input 58 (e.g., protocol conversion, cable modem, satellite system, and so forth), fixed data stores 60 (e.g., memory, or disk drive), and removable media devices 62 (e.g., memory cards, CD, DVD, Blu-Ray™, and so forth).

A means is provided in the system for identifying the presence of at least one selected individual. In preferred embodiments this means comprises a key (e.g., mechanical and/or electronic), remote control device, or a combination thereof which are configured for communicating proximity to the video output apparatus. FIG. 1 depicts hardware associated with a few different mechanisms for implementing this aspect of the present invention.

A separate wireless remote control 20, such as shown in the form of a small remote control box, or key fob, is configured for communicating with the controller 12 of the video output device. Use of a separate wireless remote control has the advantage that the parent, or other supervisory person (e.g., caretaker in a care facility, and so forth) can maintain possession of the device, or store it where it is not readily obtained by unauthorized persons. The separate wireless remote does not need to provide any function controls whatsoever, as in one embodiment it need only be configured to automatically communicate a proximate location to the video output device when placed in sufficient proximity thereof. In another implementation a single input from the remote control toggles the parent control restrictions between on and off.

By way of example, the separate wireless remote control can be implemented as a radio-frequency identification (RFID) circuit for responding to challenges transmitted from the video apparatus. If implemented as a passive device, the remote control receives power and data from challenges transmitted by the video output apparatus, wherein it transmits a response, such as including a device identifier. If implemented in this manner the small remote control can operate without the need of batteries or any associated internal power source. The remote control can be configured in various semi-passive and active configurations as well.

Inputs can be registered by remote control 20 and passed to video control circuit 12, such as represented by a bio-metric sensing device 32, up/down selection buttons 34a, 34b, and input button 36. The bio-metric sensor 32 is shown for capturing a thumb ‘print’, wherein the pressure applied to the sensor in response to the thumb ridge topography is compared against identifier data captured for the selected users (i.e., supervisory parties). In addition, print scanners are increasingly incorporating the ability to detect blood flow and even blood flow patterns to assure that prints are not registered from casts of the person's thumb.

Upon receiving fingerprint information the programming of controller 22 attempts to match the received bio-metric data against the information stored for the registered individuals (i.e., parents and supervisory individuals), such as person1 and person2 within data file 26 of memory 24. If a match is found, then the setting information is checked along with any additional input that may be received from the remote control device, if it is configured with additional buttons or similar selection input means. The response of the video apparatus is determined from checking settings and inputs wherein the parental restriction levels are temporarily changed accordingly, such as lifting restrictions or providing a change of restrictions. The temporary restrictions are then later abandoned, the time or event upon which they are abandoned is determined by how the durations of the restrictions are defined, such as in response to elapsing of a time period, reaching the end of the next half-hour or hour, the conclusion of a specific program, in response to an event, and so forth.

The optional inclusion of various selector inputs (i.e., buttons) allows the user to control specifics of the parental restrictions as well as to allow the addition of ongoing functionality. Examples of parental restriction control include temporarily increasing or decreasing content restriction levels, setting duration of the over-ride, setting over-ride event and so forth. In addition, it should be appreciated that the separate remote control could be used to execute additional functionality, such as activating equipment (e.g., program source, set top box, satellite receiver), and other functionality not within the present teachings.

If buttons are incorporated within remote control 20, then it may be desirable to incorporate an On/Off or lockout selector 38 (i.e., a sliding mode selector), wherein accidental depression of the buttons, such as when the device is retained in a pocket, does not cause unwanted changes to parental restriction settings. The inputs can be utilized with any form of remote control devices, including remote controls operating in passive, semi-passive and/or active modes.

Returning to the use of bio-metric sensing of a supervisory party in the vicinity of the video apparatus, it should be noted that according to the present invention, bio-metric identifiers can be utilized in devices other than the separate remote controller to facilitate the setting or lifting of temporary control restrictions. Remote control 18 is shown with an optional bio-metric sensor 40, such as for detecting a fingerprint. In this case remote control 18 is configured for communicating information registered about the fingerprint to controller 22, wherein programming performs a comparison against the database of data for the supervisory persons and upon detecting a valid match the programming executes the temporary change in content restrictions, and establishes the conditions under which this temporary change is to be withdrawn, such as setting a time out interval. Alternatively, a bio-metric sensor 54 can be incorporated within television 14 according to present invention, wherein users identify themselves and the system temporarily adjusts the parental control restrictions. Regardless of the device into which it is incorporated, the sensor assures that the selected individual is in the vicinity (i.e., same room) when the parental control restriction is adjusted and/or the video content is being output.

As an alternative to a remote control, a mechanical or electrical key device can be implemented for communicating proximity to the video apparatus. The key can be configured for insertion within or proximal to video apparatus 12, video output device 14, input source group 16, or within remote control 18. The inclusion of a key input on separate remote control 20 can also be implemented, however, this arrangement appears somewhat redundant. By way of example and not limitation, an electronic key 48 is shown in preparation for insertion within slot 50 of the television. A receptacle for a mechanical or electrical key is shown as slot/compartment 52 of television (monitor) 14, or as slot/compartment 42 on remote control 18. Furthermore, an otherwise conventional remote control can be adapted for receiving a key for controlling the parental restrictions.

The key device can be detected on the basis of mechanical registration (e.g., aligned and rotated to trigger a switch), electrical properties (e.g., detected in response to engaging a set of contacts), or in response to its proximity as detected electronically (e.g., sensing based on electrical activity within approximately 1-3 feet). In the case of a proximity based electrical key, the programming of the video apparatus continually or periodically detects the relative location (e.g., proximal, in-range, out of range) of the key device. In one mode of the apparatus, the key needs to remain inserted, engaged or within the readable vicinity for the change in parental control restrictions to remain in effect. Upon removal, the parental restrictions revert to their prior setting. It should be noted that restriction changes may be accepted from inserting a key into slot/compartment 42 of the wireless remote control in a similar manner, if desired, however it is more likely for the user to retain possession of a key fob when traversing the area of the display apparatus.

An implementation of the present teachings also describe a method of adjusting parental control of video output, comprising the following elements: (a) Entering identifiers, within a data store of a video device, for at least one supervisory individual, or device associated with the supervising individual(s), for which parental control restrictions are to be adjusted. The identifiers can be bio-metric information for identifying the individual, or device identification (e.g., unit number) for a particular device, or a combination thereof. (b) Establishing a parental control restriction setting for controlling the content that is to be output by video device. The restriction can be set by conventional setting mechanisms wherein typically a threshold level is set for determining which content to allow or alternatively to block. (c) Generating of a video output from a video content source input (e.g., stream or file) when the ratings of the video content source is compatible with the parental control restriction setting. The “compatibility” refers to the content within the threshold(s) of content to be allowed, and/or content that is not to be blocked. (d) Temporarily changing parental control restrictions in response to detecting the presence of the at least one supervising individual, or the device associated with the at least one supervising individual(s). It should be understood that this step can be performed at any desired location within the list of steps above.

It should be appreciated that the duration of these “temporary” changes to parental control restrictions can be limited in duration through a number of alternative ways according to the invention. By way of example and not limitation, these ways to limit the duration include the following. (1) Establishing a predetermined time period over which the parental control settings are retained. The predetermined time period can be of a fixed length, or variable as determined in response to parameters or conditions, such as set by the user. (2) The restriction change can be temporarily retained for as long as the supervisory individual(s) are detected within a desired vicinity of the video device. (3) The temporary restriction settings can be retained for a predetermined or variable period of time after the supervisory individual(s) leave the room, such as for instance X minutes, wherein X is defined in the user settings. (4) The temporary restriction setting can be maintained while the present content is being viewed, such as for the remainder of an element of content (e.g., movie or program), or of a subsequent element of content. (5) Temporary restriction settings can be maintained for a limited duration in response to any desired alternatives to the above and combinations thereof. Changing the restrictions immediately upon the supervisory person, or associated device, leaving the proximity of the video device would cause problems as the program being displayed could change every time the parent, or other supervisor, left the room—very disconcerting to viewers.

The parental control restrictions can be changed in different ways, such as by automatically changing to a new restriction level or receiving input as to how to change the restrictions. By way of example the restrictions can automatically defeat all the parental control restrictions in response to detecting the presence of a supervisory party, or the device associated with that person or persons. As a variant, the restrictions can be automatically changed to a value in response to parameters set by the supervisory party. Alternatively, or additionally, user input can be received from the supervisory individual(s) when they are within a detected proximity of the video apparatus. The method can further include automatically communicating with a remote control device that is brought into sufficiently close proximity, wherein the parental control restrictions can be temporarily changed.

In one implementation, or mode, the change in parental control restrictions involves deactivating the video output of the content source when the supervisory individual, or device associated with the supervisory individual, is not present. For example, as the supervisory party leaves the room the video output is blanked, or the television enters a stand-by mode or off mode. This implementation supersedes the restrictions by restricting all content viewing unless at least one supervisory individual is present. Less preferably a content switch can be executed to a source of content that is not subject to restriction, or that is within the prevailing content restrictions.

The method can also include specific methods of detecting the presence of supervisory individuals (users). Detection of supervisory persons can be performed in a number of ways, including: (i) receiving bio-metric information from a bio-metric sensor, such as integrated on the video apparatus or a remote control device associated with the video device and brought into sufficient proximity; (ii) the remote control configured for communicating bio-metric identification for an individual utilizing the remote control; (iii) looking up the bio-metric information in the data store of the video device; and (iv) temporarily changing parental restrictions in response to finding a match between the received bio-metric information and identifiers retained within the data store for supervisory individuals which are designated to adjust parental control restrictions.

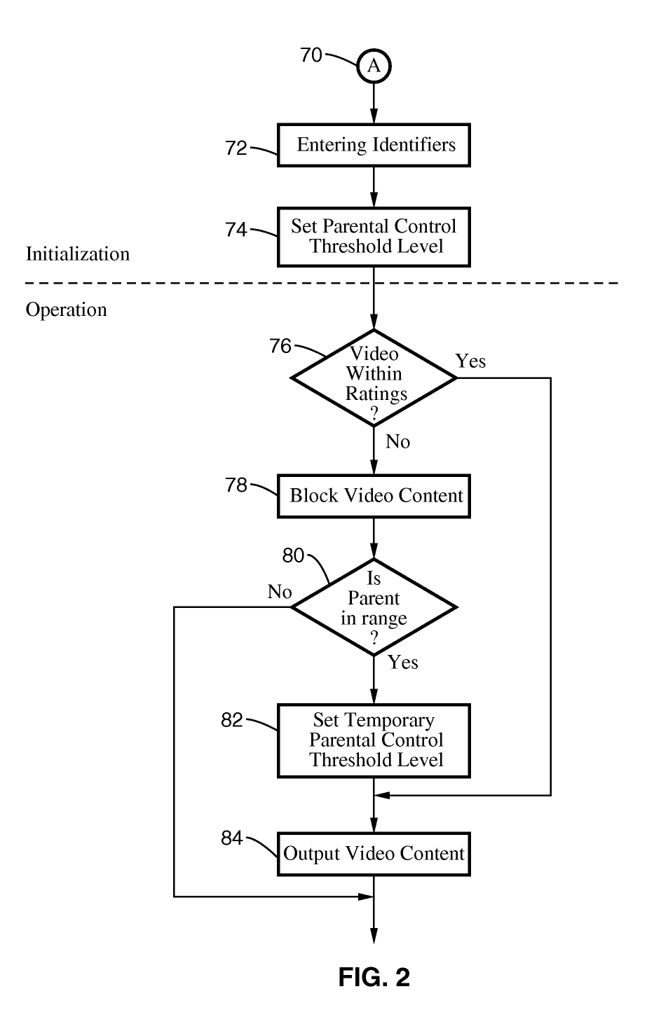

FIG. 2 illustrates an example embodiment of a method for performing a convenience mode control. While video device programming 70 is executing, block 72 is reached at which point aspects of the video device parental control are setup, such as with preferences being established and identifiers entered as necessary for the supervisory users or the devices associated with the supervisory user(s) (e.g., for parent or supervisor(s) that are allowed to temporarily change the thresholds for supervising content output.

Parental control restriction settings (thresholds) are established at block 74 for controlling the ratings of content whose video is being output by video device. In block 76 the ratings of the video content are checked in relation to the parental control restriction threshold(s) set by the parent or responsible user. If the ratings of the video content source is incompatible with the parental control restriction setting, then the video content is blocked at block 78. If a supervisory person, or device associated thereof, is detected (i.e., within range) as represented by block 80, then at block 82 the parental control restrictions are temporarily changed. Once the parental control thresholds are changed, the video content is output as per block 84. It should be appreciated that in certain applications, the thresholds may be changed and not entirely lifted, wherein execution returns to block 76, wherein the ratings are checked again prior to outputting the content.

Returning to block 80, in the case of the parent not being in range, then the blocking of the content remains in place and execution branches past block 84. Returning to block 76, when the video content is within the ratings, then execution proceeds directly to block 84 which is directed to output the content.

It should be kept in mind that the previous figure describes an embodiment of the method, wherein those of ordinary skill in the art will appreciate that the control of content with respect to temporary threshold adjustments in response to the proximity of a supervisory individual can be implemented with numerous variations without departing from the teachings herein.

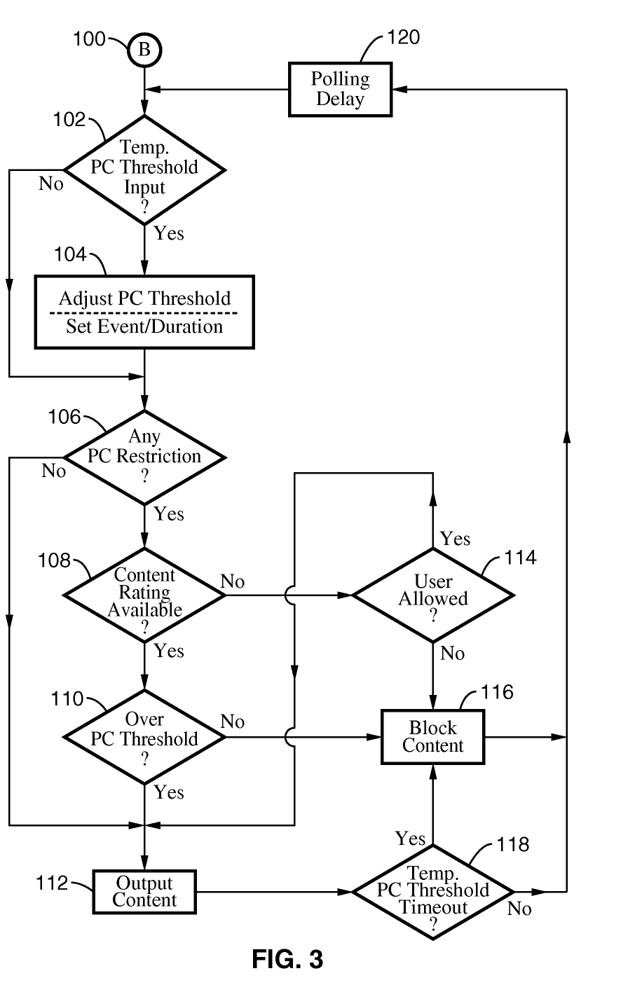

FIG. 3 illustrates an example embodiment for a variation of the method shown in FIG. 2 for adjusting parental control of video output. It should be noted that for clarity and simplicity the flowchart of FIG. 3 describes the process in a simple polling loop arrangement, however, one of ordinary skill in the art will appreciate that programming structures and arrangements can be widely varied without departing from the present method.

While performing processing through block 100 for a video device, a check is made as represented by block 102 to determine if a temporary parent control threshold input is being received. If a threshold input has been received then the current setting is saved and a temporary setting takes its place as per block 104. In addition, an event or duration is established in block 104 for restoring the original restriction setting. Block 104 is bypassed when a parental control restriction is not being set. If any parental restrictions are set as detected by block 106, then a check is made to determine if a content rating is available for the specific content as per block 108. If no content available, a check is made for user options at block 114. If the user allows content output of material without a rating, then the content is output as per block 112, otherwise content is blocked as per block 116. Returning to block 108, if a rating is available, then a check is made at block 110 to determine if the rating is incompatible with the parental control threshold. It should be appreciated that ratings can be framed as content to be allowed or content to be blocked and that many categories of ratings (e.g., overall, sexual content, violence, and so forth) can be supported, despite the single rating dimension depicted in this flowchart. If the content is found to be within the allowable content, then content is output at block 112. Alternatively, if the content is objectionable based on one or more aspects of the parental control thresholds, then the content output is blocked as per block 116. To prevent user confusion, it is preferable that a warning be output to the video screen indicating that this content is being blocked and the nature of why it is being blocked.

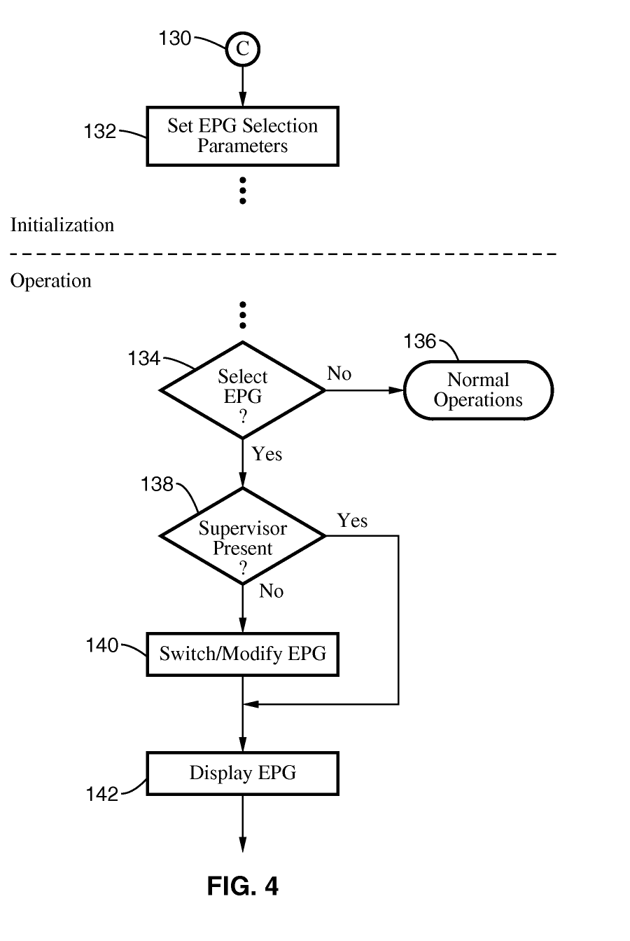

FIG. 4 illustrates a segment of flow for programming which executes according to an embodiment of the invention for automatically modifying the electronic programming guide (EPG) based on supervisory input. Execution enters this segment of programming at 130 and the user can set EPG selection parameters as per block 132 within an initialization sequence. The selection parameters determine if, how and under what circumstances the EPG is to be changed based on a determination of whether a parent or supervisor is present (active or passive detection). For example, the user can select an alternate EPG, or specifically select which sources are not to be displayed on the EPG when a supervisory party is not present.

Typically, the presence of the supervisory individual(s) would open up the EPG to display all of the available sources, however, the programming can be configured to allow the supervisor to remove certain video sources in response to their presence, for example stations containing children's programming. In this way the system can provide maximum flexibility as desired and even automatically customize the programming guides based on whom is present. In another variation, the ordering of the video sources listed in the EPG is modified in response to detecting the presence of specific individuals, such as the supervisory individuals.

During operation, if the user does not select entry to the EPG then programming continues normally at block 136. Prior to entering the electronic program guide (EPG), programming represented by block 138 determines if the supervisory party can be considered to be present, such as according to any of the techniques previously described with regard to adjusting parental control restrictions. If the supervisor is not detected, then the EPG is modified, or another appropriate EPG is selected (i.e., a switch made to a subset EPG containing fewer sources), as per block 140 which contains only the desired set of sources, typically those with ratings that correspond to the parental control threshold wherein persons are not tempted by seeing listings for content that is not available to them. Either of these EPGs is output at block 142. It should be recognized that the system can be configured to provide a range of EPG outputs as desired, based on the user setup and the detected conditions.

It should be appreciated that the programming segment is shown by way of example, wherein one of ordinary skill in the art will recognize that the functions can be implemented in a number of alternative ways without departing from the teachings of the present invention. In addition, it should be appreciated that the modification or switching of the EPG can be performed as an option associated with changing of the parental control restrictions or it may be implemented separately from that functionality.

The examples of FIG. 2 and FIG. 4 are simplified for the sake of clarity and it should be recognized that the actual programming can follow infinite variety of form, flow and ordering while still performing functions according to the present teachings and thus without departing from the teachings of the present invention.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus, comprising:
means for generating a video output from a video content source;
means for preventing the output of selected video content in response to detecting that its rating is incompatible with a parental control restriction setting; and
means for temporarily changing parental control restrictions in response to identifying the presence of at least one supervisory individual, or a device associated with the presence of said at least one supervisory individual.

2. An apparatus as recited in claim 1, wherein said means for generating a video output is selected from the group of video devices consisting of analog TV sets, digital TV sets, set top boxes, video players, fixed media players, digital video recorders (DVRs), removable media players, digital video disc (DVD) players, personal computers, video gaming systems and combinations thereof.

3. An apparatus as recited in claim 1, wherein said video content source comprises broadcast content selected from the group of broadcast content forms consisting of radio frequency, Internet, cable, satellite, and local network.

4. An apparatus as recited in claim 1, wherein said means for temporarily changing parental control restrictions is configured for allowing the output of all video content in response to identifying that said at least one supervisory individual or the device associated with said at least one supervisory individual, is proximal to the apparatus.

5. An apparatus as recited in claim 1, wherein said means for temporarily changing parental control restrictions is configured for temporarily defeating or over-riding parental control restrictions.

6. An apparatus as recited in claim 5, wherein said temporarily changing parental control restrictions is executed without requiring user entry of a password, or traversal of one or more menus.

7. An apparatus as recited in claim 1:
wherein the parental control restriction comprises a threshold for selecting content in at least one category for viewing; and
wherein if the rating of the given content element in that category is within the parental control threshold setting, then the given content element will be output for viewing.

8. An apparatus as recited in claim 1:
wherein the parental control restriction comprises a threshold for selecting content in at least one category for being blocked; and
wherein if the rating of the given content element in that category is within the parental control threshold setting then the given content element will be blocked from being output.

9. An apparatus as recited in claim 1, wherein said identifying the presence of at least one supervisory individual comprises a mechanical or electrical key device configured for communicating in response to being located proximal to said apparatus.

10. An apparatus as recited in claim 1, wherein said mechanical or electrical key device is configured to over-ride parental control levels in response to being engaged with said apparatus.

11. An apparatus as recited in claim 1, wherein said electrical key device comprises a remote control device configured for wireless communication with said apparatus.

12. An apparatus as recited in claim 11, wherein said remote control device further comprises a user interface allowing the user to set a specific level of parental control restriction.

13. An apparatus as recited in claim 11, wherein said remote control device is configured with a radio-frequency identification circuit for responding to challenges transmitted from said apparatus.

14. An apparatus as recited in claim 13, wherein said remote control device further comprises a bio-metric sensor configured for identifying that said remote control device is in the possession of one or more supervisory individuals prior to enablement of the remote control functionality.

15. An apparatus as recited in claim 1:
further comprising a remote control device utilized for controlling operations on said apparatus;
wherein said identifying the presence of at least one supervisory individual comprises comparing information received from a bio-metric sensor integrated on said remote control device with supervisor information contained within a database;
wherein said remote control configured for communicating bio-metric identification for an individual utilizing said remote control in the capacity of a content supervisor; and
wherein said means for temporarily changing parental restrictions is configured for changing the parental restrictions in response to matching the bio-metric identifier with information retained about individuals having supervisory privileges.

16. An apparatus as recited in claim 1, further comprising means for temporarily changing the listings shown on an electronic program guide in response to identifying the presence of at least one supervisory individual, or a device associated with said at least one supervisory individual.

17. An apparatus for generating video output, comprising:
a controller circuit configured for generating a video output from a video content source;
said controller circuit having at least one computer processor;
a memory coupled to said controller circuit and adapted for retaining parental control restriction settings and identification information for supervisory individuals or devices associated with said supervisory individuals, for which parental control restrictions can be temporarily over-ridden;
programming executable on said computer processor for,
preventing the output of selected video content in response to detecting that its rating is incompatible with a parental control restriction setting,
temporarily changing parental control restrictions in response to identifying the presence of at least one supervisory individual or a device associated said at least one supervisory individual, for which information is retained in said memory.

18. A method of adjusting parental control of video output, comprising:
entering identifiers, within a data store of a video device, for at least one supervisory individual or device associated with said supervisory individual, for which parental control restrictions are to be adjusted;
establishing a parental control restriction setting for controlling the ratings of content whose video is being output by video device;
generating a video output from a video content source when the ratings of the video content source is compatible with the parental control restriction setting; and
temporarily changing parental control restrictions in response to detecting the presence of said at least one supervisory individual, or said device associated with said at least one supervisory individual.

19. A method as recited in claim 18, wherein said changing of parental control restrictions comprises automatically defeating all said parental control restrictions in response to detecting the presence of said at least one supervisory individual, or said device associated with said at least one supervisory individual.

20. A method as recited in claim 18, wherein said changing of parental control restrictions comprises receiving a user input associated with the presence of said at least one supervisory individual or said device associated with said at least one supervisory individual, and setting said parental control restriction in response to said user input.

21. A method as recited in claim 18, wherein said changing of parental control restrictions comprises deactivating the output of video from the content source when said at least one supervisory individual, or said device associated with said at least one supervisory individual, is not present.

22. A method as recited in claim 18, further comprising:
automatically communicating from a video device to a remote control device that is brought into a desired range of proximity; and
temporarily changing parental control restrictions in response to determining that information about the remote control or the supervisory individual associated with the remote control, is found in the data store as being an individual for which parental control restrictions are to be adjusted.

23. A method as recited in claim 18, further comprising:
receiving bio-metric information from a bio-metric sensor integrated on a remote control device which is proximal to said video device;
said remote control configured for communicating bio-metric identification for a supervisory individual utilizing said remote control;
looking up said bio-metric information in said data store of said video device; and
temporarily changing parental restrictions in response to finding a match between the bio-metric information and identifiers within the data store of supervisory individuals for which parental control restrictions are to be adjusted.
